(19) United States
(12) Patent Application Publication
(10) Pub. No.: US 2025/0236424 A1
(43) Pub. Date: Jul. 24, 2025

(54) METHOD FOR CONTROLLING A PACKAGING MACHINE

(71) Applicant: Focke & Co. (GmbH & Co. KG), Verden (DE)

(72) Inventors: Stephan Schröter, Bücken (DE); Steffen Bohnhorst, Hellwege (DE); Aleksandar Vujevic, Hannover (DE)

(73) Assignee: Focke & Co. (GmbH & Co. KG), Verden (DE)

(21) Appl. No.: 18/698,050

(22) PCT Filed: Sep. 27, 2022
(86) PCT No.: PCT/EP2022/076807

§ 371 Date: Apr. 3, 2024

(30) Foreign Application Priority Data
Oct. 6, 2021 (DE) 102021125973.8

(51) Int. Cl. B65B 19/28; B65B 19/04; B65B 19/22; B65B 35/40; B65B 57/00; G05B 17/02

(52) U.S. Cl. CPC B65B 19/28; B65B 19/04; B65B 19/221; B65B 35/405; B65B 57/005; G05B 17/02

(57) ABSTRACT

A method for controlling a packaging machine for producing wrappers, in particular for producing wrappers for smokable products of the tobacco industry, with several drives capable of being activated independently of one another which move machine elements of the packaging machine on trajectories on which the machine elements might collide with one another or with another component of the packaging machine or with products being handled in the packaging machine, by creating a digital simulation model of the packaging machine is created, simulating differing relative positions of the drives and the states of the packaging machine, ascertaining collision-free traversing paths for the machine elements, and moving the machine elements of the packaging machine respectively along the ascertained collision-free traversing paths.

### CROSS REFERENCE TO RELATED APPLICATIONS

This application is the US national phase of and claims the benefit of and priority on International Application No. PCT/EP2022/076807 having an international filing date of 27 Sep. 2022, which claims priority on and the benefit of German Patent Application No. 10 2021 125 973.8 having a filing date of 6 Oct. 2021.

### BACKGROUND OF THE INVENTION

### Technical Field

The present invention relates to a method for controlling a packaging machine for producing wrappers, in particular for producing wrappers for smokable products of the tobacco industry, and also to an apparatus for producing such wrappings, with several drives capable of being activated independently of one another which move machine elements of the packaging machine on trajectories on which the machine elements might collide with one another or with another component of the packaging machine or with products being handled in the packaging machine. The invention relates, moreover, to an apparatus for producing such wrappings.

### Prior Art

In packaging machines, the mechanical (kinetic) coupling of individual, moving machine elements—such as slides, conveyors, turrets, etc.—to a rotating main shaft or master shaft has been abandoned more and more in recent years in favor of individual servo drives for these machine elements, which are electronically coupled to a clock signal of the machine. However, with the use of separate servo drives for the individual moving machine elements the risk of collisions between a machine element or a product being handled by such a machine element and other fixed or moving parts of the equipment, in particular another moving machine element, naturally increases. If, for instance, the trajectories of several moving machine elements within a working space that is common in this respect overlap or come very close to one another during the operation of the machine, this risk is particularly high. Faulty activations, material breakages or other faults may then quickly result in collisions. Analogous problems may also arise in the course putting such a packaging machine into operation or in the course of the maintenance thereof.

### BRIEF SUMMARY OF THE INVENTION

Proceeding from this, the object of the present invention is to specify a packaging machine of the type described in the introduction, as well as a method for controlling such a machine, with which machine elements, in particular during the operation of the machine, during the process of putting the machine into operation and/or during maintenance, can be moved in as reliable and easy a manner as possible without colliding.

This object is achieved by a method for controlling a packaging machine for producing wrappers, in particular for producing wrappers for smokable products of the tobacco industry, with several drives capable of being activated independently of one another which move machine elements of the packaging machine on trajectories on which the machine elements might collide with one another or with another component of the packaging machine or with products being handled in the packaging machine, with the following steps: a) a digital simulation model of the packaging machine is created, in particular by means of a simulation program, reproducing (at least) the drives and the machine elements; b) with the aid of the simulation model, differing relative positions of the drives and the states of the packaging machine, in particular of the machine elements, arising at these relative positions are simulated; c) within the scope of these simulations, collision-free traversing paths for the machine elements are ascertained, in particular by means of a simulation program or the simulation program; and d) the machine elements of the packaging machine are moved respectively along the ascertained collision-free traversing paths by appropriate control of the drives.

This object also is achieved by a packaging machine for producing wrappers, in particular for producing wrappers for smokable products of the tobacco industry, with several drives capable of being activated independently of one another which respectively move at least one machine element of the apparatus on a trajectory on which the machine elements might collide with one another or with another component of the apparatus or with products being handled in the apparatus, in which connection a computing device has been assigned to the apparatus, in particular exhibits said device, which has been designed and set up in such a manner that a digital simulation model of the packaging machine, reproducing (at least) the drives and the machine elements, is capable of being created with it, in particular by means of a simulation program installed on the computing device, with the aid of which differing relative positions of the drives and the states of the packaging machine arising in these relative positions, in particular of the machine elements, are capable of being simulated, in which connection collision-free traversing paths for the machine elements are capable of being ascertained within the scope of these simulations, and that a drive controller which controls the drive in such a manner that the movable machine element is moved, or capable of being moved, along the ascertained collision-free traversing paths has been assigned to each drive.

The method according to the invention is accordingly distinguished by the following steps and measures:
a) a digital simulation model of the packaging machine is created, in particular by means of a simulation program, reproducing (at least) the drives and the machine elements,
b) with the aid of the simulation model, differing relative positions of the drives and the states of the packaging machine, in particular of the machine elements, arising in these relative positions are simulated,
c) within the scope of these simulations, collision-free traversing paths for the machine elements are ascertained, in particular by means of a simulation program or the aforementioned simulation program,
d) the machine elements of the packaging machine are moved respectively along the ascertained collision-free traversing paths by appropriate control of the drives.

Within the scope of the method according to the invention, several of the aforementioned drives and the machine elements driven respectively by said drives are accordingly considered (at least one machine element per drive). A digital simulation model of the packaging machine is created that encompasses the entire packaging machine or parts thereof together with the drives and machine elements being considered. With the aid of the simulation model, differing relative positions of the drives and the states of the packaging machine arising at these relative positions, in particular, are then simulated, in particular the states or the corresponding positions of the machine elements and also, where appropriate in addition, possible movements of the drives and/or machine elements, and within the scope of these simulations (on the basis of the simulated information or data) traversing paths for the machine elements are computed that are collision-free—that is to say, traversing paths in the case of which no collision occurs with, in each instance, another machine element, with some other component of the machine, or with a product being handled in the machine.

As far as the simulations and the determination of the collision-free traversing paths are concerned, these can be carried out during the operation of the packaging machine, in particular cyclically or continuously, or before or during a process of putting the packaging machine into operation or before or during the maintenance thereof.

Naturally, all the drives of the packaging machine that move machine elements that may potentially be involved in a collision in the described manner are preferably incorporated into the simulation model. However, this is not mandatory. Only a subset of these drives or machine elements may be considered.

According to a preferred development of the method according to the invention, there is provision to query the actual positions of the drives, and to carry out the simulations and to determine the collision-free traversing paths on the basis of these actual positions.

In this case, for instance during the operation of the machine or during the process of putting it into operation or during the maintenance routines thereof the current actual positions of the real drives can firstly be determined or read out by means of suitable sensors; for instance, the actual rotation angles of the drive motors of these drives can be measured directly by means of suitable, assigned rotary-angle transducers.

Theoretically, the actual positions of the real drives can also be determined indirectly with the aid of appropriate position-sensors that have been assigned to the machine elements moved by the drives.

These actual positions or actual rotation angles can then be transmitted to the simulation program and used accordingly as input parameters of the simulation. The positions of the simulated or virtual drives in the simulation model can be adapted to the actual positions of the real drives of the packaging machine and, for instance, defined as initial positions of the simulated drives, so that each drive in the simulation model has an initial position that corresponds to the actual position of a real drive assigned to it.

On the basis of this simulation model adapted to the states of the real machine, diverse relative positions of the drives and the states of the packaging machine, in particular of the machine elements, resulting therefrom can then be simulated (by the simulation program), starting from the initial positions of the drives of the simulation model, which have been adapted to the actual positions of the real drives, and the collision-free traversing paths of the machine elements can then be ascertained or computed within the scope of the simulations, in particular on the basis of results of these simulations.

The computed traversing paths can then, or in the process, be converted into corresponding control commands for the respective controller of the respective drive of the respective machine element; for instance into corresponding rotation-angle defaults for the respective drive, so that the controller then controls the respective drive in such a manner that the machine element moved by the drive is moved along the collision-free traversing path.

As an alternative to the aforementioned procedure, there may also be provision, after queries of the actual positions of the drives, to select, on the basis of these actual positions, collision-free traversing paths, already ascertained previously by the simulations, from a database in which collision-free traversing paths assigned respectively to various actual positions have been stored. Accordingly, in this variant the simulations are, as a rule, not carried out “online” during ongoing operation or during a process of putting the packaging machine into operation or during maintenance thereof, but rather are stored in advance (where appropriate, far in advance), for instance a single time already within the scope of the construction of the packaging machine.

Within the scope of the implementation of the method according to the invention, the simulations, inclusive of the determination of the collision-free traversing paths, are preferentially performed by one or more computing devices—in particular, assigned to the packaging machine, for instance taking the form of computers or programmable logic controllers—preferentially by the central main control unit of the packaging machine or by one or more decentralized control units, in particular controlling the respective drive.

According to another preferred development of the invention, in the case where the trajectories of at least two machine elements intersect in a region of overlap, separations between the two machine elements and/or between one of these machine elements and a product moved by the other machine element and/or between products moved by the two machine elements—in particular, separations between the contours of the machine elements and/or between the contours of the machine element and of the product and/or between the contours of the products—that arise when the two machine elements are located in the region of overlap can be determined (in particular, computed) within the scope of the simulations for differing relative positions of the drives of the two machine elements.

Alternatively or additionally, within the scope of the simulations for differing relative positions of (at least) one drive, separations between the machine element moved by this drive and/or a product moved by this machine element, on the one hand, and a stationary component of the apparatus, on the other hand—in particular, separations between the contour of the machine element and/or the product moved by it, on the one hand, and the contour of the stationary component, on the other hand—that arise when the machine element is moved in or along the region of the stationary component can be determined (in particular, computed).

In both of the aforementioned cases, the separations can then be optimized within the scope of the ascertainment of the collision-free traversing paths, for instance by means of optimization algorithms, in particular in such a manner that the separations are at least greater than zero or preferably as large as possible.

Furthermore, there may be provision that separations between a predetermined—in particular, stored—synchronous position or target position for the machine element moved by the drive and the position of this machine element arising at the respective relative position of the drive are determined within the scope of the simulations for differing relative positions of (at least) one drive.

These separations may enter into the ascertainment of a collision-free traversing path for this machine element or further machine elements.

As far as the simulation model is concerned, it may preferentially encompass all the drives and the machine elements moved by said drives, as well as at least all the other components of the packaging machine with which the machine elements and/or the products moved by said machine elements might collide on their trajectories.

According to a further embodiment of the invention, there may be provision that within the scope of the ascertainment of the collision-free traversing paths a first collision-free traversing path is ascertained for a first machine element, and a second collision-free traversing path is ascertained for a second machine element, and that the control of the drives is undertaken in such a manner that the second machine element is moved along the second collision-free traversing path only when the first machine element has already been moved along the first collision-free traversing path, so that a sequential traversing of the machine elements takes place.

The apparatus according to the invention as claimed for producing wrappers is distinguished by several of the drives capable of being activated independently of one another which respectively move at least one machine element of the apparatus on a trajectory on which the machine elements might collide with one another or with another component of the apparatus or with products being handled in the apparatus, in which connection a computing device has been assigned to the apparatus, in particular exhibits said device, which has been designed and set up in such a manner that a digital simulation model of the packaging machine, reproducing (at least) the drives and the machine elements, is capable of being created with it. This is done, in particular, by means of a simulation program installed on the computing device, with the aid of which differing relative positions of the drives and the states of the packaging machine, in particular of the machine elements, arising at these relative positions are capable of being simulated, in which connection the collision-free traversing paths for the machine elements are capable of being ascertained within the scope of these simulations, and in which connection a drive controller, which controls the drive in such a manner that the movable machine element is moved, or capable of being moved, along the ascertained collision-free traversing paths, has been assigned to each drive (each drive exhibiting, in particular, one such controller).

Further features of the present invention are evident from the appended dependent claims, from the following description of preferred embodiment examples, and also from the appended drawings.

### BRIEF DESCRIPTION OF THE DRAWINGS

FIG. 1 shows a portion of an apparatus according to the invention for producing wrappings for tobacco products, with several independent drives which move machine elements, wherein in a first region of overlap the trajectories of two machine elements overlap, and in a second region of overlap the trajectory of a machine element overlaps with the trajectory of products that are moved by a machine element.

FIG. 2 shows a side view of the apparatus along the direction of view II.

FIG. 3 shows a section along the line of intersection III-III in FIG. 2.

FIGS. 4a and 4b show the detail IVa from FIG. 3, namely an individual carrier of a conveyor, the upper entrainment part of which is located eccentrically with respect to an X-coordinate within a pouch of a pouch-conveyor (side view (FIG. 4a)), so that a correction of position in the X direction is required, and the upper entrainment part of which deviates with respect to a Z-coordinate from a predetermined synchronous position within the pouch (cross-section (FIG. 4b)), so that a correction of position in the Z-direction is required.

FIGS. 5a and 5b show representations of the detail IVa from FIG. 3, analogous to FIGS. 4a and 4b, though after a correction of position in the X-direction by traversing the pouch in the direction of the arrow in FIG. 5a.

FIGS. 6a and 6b show representations of the detail IVa from FIG. 3, analogous to FIGS. 4a and 4b, though after a subsequent (additional) correction of position in the Z-direction by traversing the carrier in the direction of the arrow in FIG. 6b.

### DETAILED DESCRIPTION OF PREFERRED EMBODIMENTS

The relationships according to the invention that have been presented in the foregoing will be elucidated in the following with reference to a special apparatus for the packaging of products, namely a packaging machine 10 for the packaging of cigarettes 11, or for producing cigarette wrappings with cigarettes 11 as wrapping contents, which for this purpose has been represented only selectively. Packaging machines for cigarettes or for other products are known to a person skilled in the art and will therefore not be described in any detail in the present document. It will be understood that the method according to the invention is also capable of being used with other types of packaging apparatus or packaging machine.

Furthermore, it will be understood that the method according to the invention can be used in any regions of a packaging machine in which two or more machine elements, driven by drives, of the packaging machine are moving on trajectories within a working space in which collisions of a moving machine element with another moving machine element, with some other (also static) component of the packaging machine, or with products being handled in the machine, may occur.

A region of the packaging machine 10 is shown in which cigarettes 11 are pushed or slid, in groups and cyclically, out of a cigarette magazine 13 into machine elements, held in readiness in positionally precise manner, moved (on) cyclically by a drive A, and in the present case taking the form of pouches 14 of a circulating pouch-conveyor 15, by means of machine elements, in the present case taking the form of pushers 12, moved back and forth by a drive C in the rhythm of the machine.

The trajectory of the cigarette groups and the trajectory of the pouches 14 intersect in an overlapping and accepting region 22 in which, for instance in the case of erroneously positionally inaccurate—for instance, laterally offset—alignment of the pouches 14 a collision of the respective cigarette group with one of the pouch walls of the pouches 14 may occur.

The pouch-conveyor 15 subsequently conveys the cigarette groups cyclically in the direction of a circulating carrier-conveyor 16 which possesses individual machine elements, moved by a drive B and in the present case taking the form of carriers 17, which are moving on a conveying path extending at right angles to the conveying plane of the pouches 14.

In an overlapping and accepting region 18, in which the conveying path or trajectory of the pouches 14 and the conveying path or trajectory of the carriers 17 intersect, in each instance an upper carrier part 21, adapted to the inner contour of the respective pouch 14, of one of the carriers 17, is moved lengthwise through a pouch 14 held respectively in readiness, and thereby conveys the cigarette group located in the pouch 14 (entraining the same) at right angles to the conveying plane of the pouches 14 out of the pouch 14 in the direction of a subsequent wrapping station 19 in which an inner blank 20 is then placed onto the cigarette group and folded around it.

Collisions may occur also in overlapping and accepting region 18, for instance a collision of a carrier 17 with a pouch 14 held in readiness, or with a pouch wall of the same, in the case of erroneously positionally inaccurate alignment of the pouches 14 relative to the carriers 17, or to the upper carrier parts 21.

The drives A, B, C are capable of being activated individually and in the present case have each been designed as servo drives with servomotor and appropriate positional control.

In the present case, the pushers 12, the pouches 14 and the carriers 17 constitute the machine elements moved by the drives C, A and B respectively, which in accordance with the invention are to be moved in collision-free manner. The invention is naturally not restricted to these special machine elements; rather, all conceivable machine elements moved respectively by drives may be encompassed by the invention.

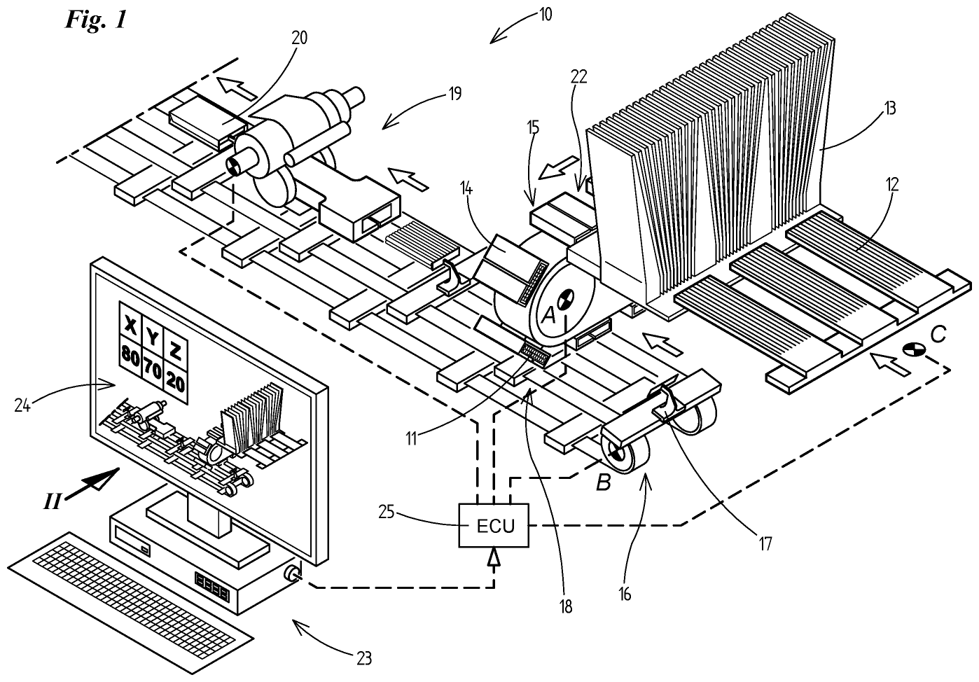

In order, for instance, to enable reliable, collision-free movements of the machine elements 12, 14 and 17 also in the overlapping regions 18 and 22 in the course of the process of putting the packaging machine 10 into operation but also within the scope of maintenance or during regular, ongoing production operation, in the present case a simulation model 24, namely a digital reproduction 24 or a digital twin of the machine region shown in FIG. 1, is created, with the aid of a computing device 23 (PC), as a kinematic substitute model which, in particular, reproduces the individual machine elements 12, 14, 17 together with their drives. The simulation model 24 preferably encompasses all the mechanisms of the packaging machine—that is to say, moved and unmoved machine elements or machine components, as well as the products being handled in the machine. All the mechanical relationships of the mechanisms relative to one another have preferably been stored.

A person skilled in the art knows how such a simulation model 24, or such a digital twin, can be created.

By means of this digital simulation model 24, many or all of the possible relative positions of the drives and also movements of the same and the states, or positions, and movements of the machine elements 12, 14, 17 arising at these relative positions or in the course of these movements can then subsequently be simulated by means of a simulation program running on the computing device 23.

For this purpose, the current actual positions of the drives A, B and C—that is to say, for instance, the real, current actual rotation angles—can be captured in a first step (by means of rotary-motion transducers). These actual positions or actual rotation angles are then transmitted to the simulation program and used accordingly as input parameters of the simulation. In other words, the mechanisms that are present or reproduced in the simulation model 24 are aligned in accordance with the respective position in the real packaging machine 10.

Accordingly, the positions of the virtual/simulated drives A, B, C in the simulation model 24 are adapted to the actual positions of the real drives A, B, C of the packaging machine 10 and defined, for instance, as initial positions of the virtual/simulated drives A, B, C, so that each drive A, B, C in the simulation model 24 has an initial position that corresponds to the actual position of the real drive A, B, C assigned to it.

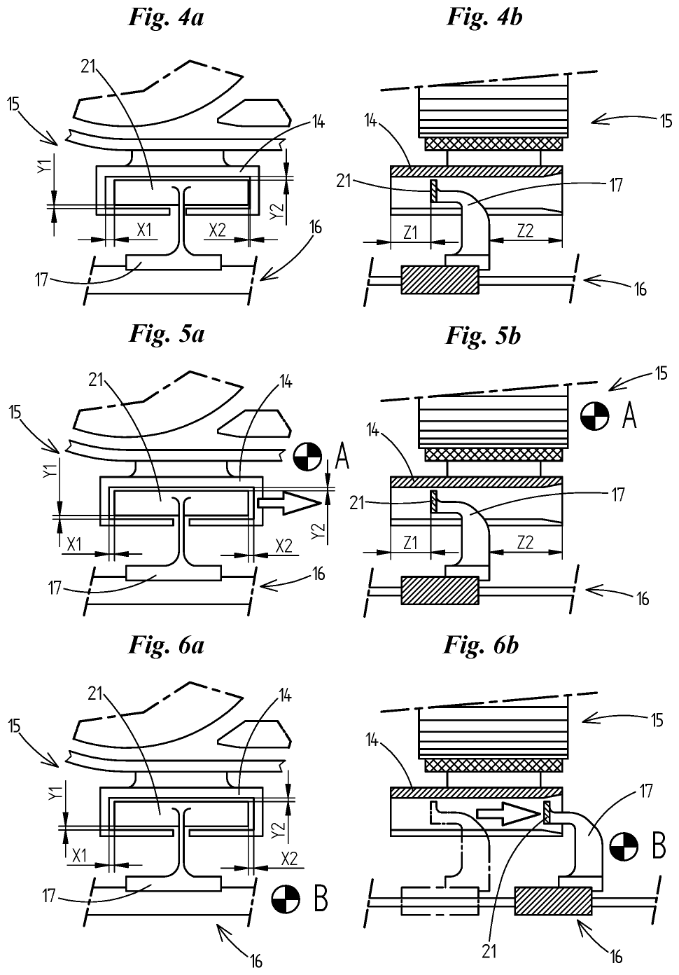

In a subsequent step, measurements of separation or ascertainments of separation are performed in the present embodiment example on the basis of the transmitted actual positions of the drives with the aid of, or on the basis of, the simulation model 24. Amongst other things, separations between the contours or certain points of the machine elements 12, 14, 17 may be considered, and also separations between an actual position of a machine element 12, 14, 17 and a predetermined synchronous position. This will be elucidated in more detail in exemplary manner with reference to FIGS. 4a-6b.

In FIG. 4a it can be discerned that the upper carrier part 21 is arranged in the pouch 14 eccentrically with respect to the X-coordinate but not with respect to the Y-coordinate. The eccentric positioning with respect to the X-coordinate might result in collisions.

This is established within the scope of the simulations by reference to the simulation model, by the separations X1 and X2 from, respectively, the left and right pouch walls and the separations Y1 and Y2 from, respectively, the lower and upper pouch walls being ascertained on the basis of the actual positions of the drives A, B, C and also on the basis of all the other relationships reproduced or stored in the simulation model.

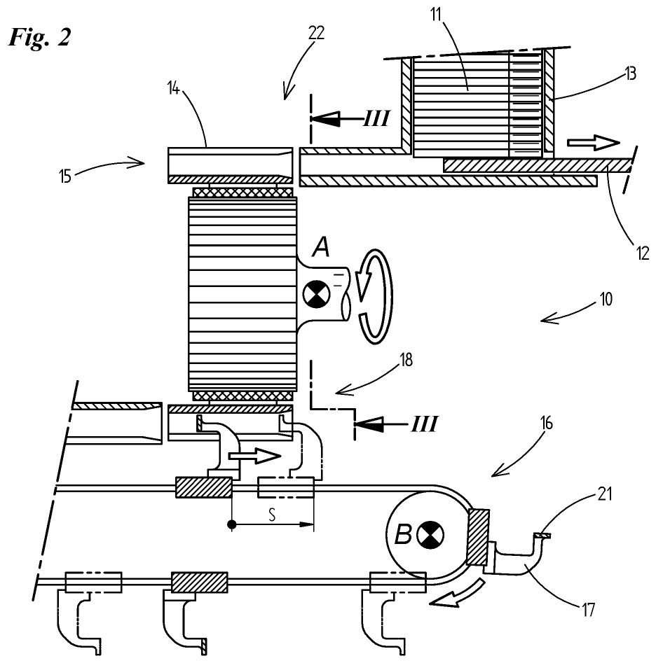

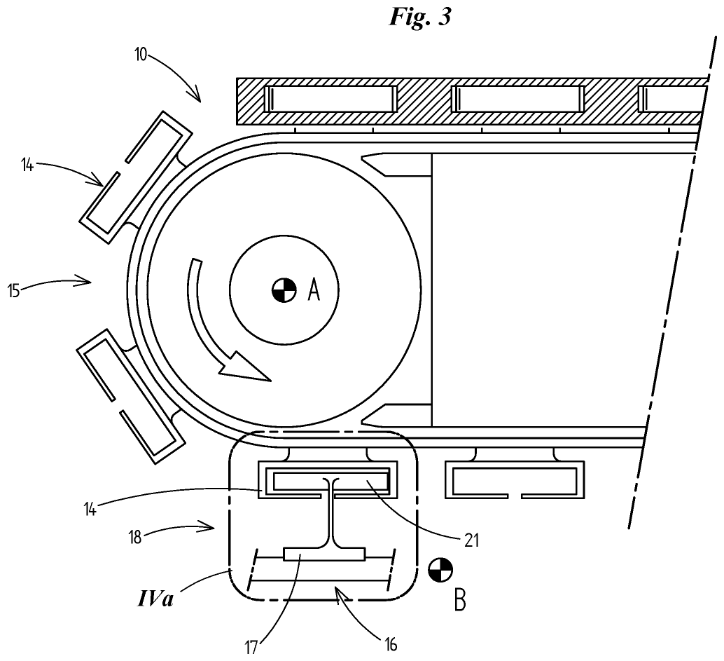

By comparison of FIG. 4b and FIG. 6b, it can be discerned that with regard to the Z-coordinate the upper carrier part 21 is located within the pouch 14 in a position that does not correspond to a predetermined target position or synchronous position shown in FIG. 6b (in FIG. 2 this target position or synchronous position is represented by dash-dotted lines). In order to establish this, the separations Z1 and Z2 relative to, respectively, a front and a rear pouch edge, for instance, might then be ascertained within the scope of the ascertainments of separation.

In a further step, collision-free traversing paths for the drives A, B, C, or for the machine elements 12, 14, 17, can then be ascertained or computed within the scope of the simulations (by means of the simulation program) by reference to the simulation model and on the basis of the ascertainments of separation carried out.

With regard to the example shown in FIGS. 4a-6b, within the scope of the simulations a collision-free traversing path for the carrier 17, or for the carrier part 21, and also for the pouch 14, on which the carrier 17, or the pouch 14, might be traversed, starting from the respective actual position, without the carrier 17 and the pouch 14 colliding with one another, can be respectively computed.

An optimizing algorithm that corrects the ascertained separations may come into play, for instance in such a manner that the separations X1 and X2 are of equal magnitude immediately afterward, so that after the correction the carrier part 21 has a maximum possible separation on both sides from the respectively adjacent pouch wall and would accordingly be positioned centrally in the pouch 14.

A first ascertained (partial) traversing path of a collision-free traversing path for the pouch 14 might/would therefore comprise moving the pouch-conveyor 15 in the arrow direction shown in FIG. 5a by appropriate control of drive A within the scope of the simulation, in order to bring the separations X1 and X2 to an identical value in each instance. In this process, the carrier 17 may, for instance, remain unconsidered or unmoved.

A first (partial) traversing path of a collision-free traversing path for the carrier 17 might, on the other hand, comprise bringing the position thereof with respect to the Z-coordinate into register with the predetermined target position or synchronous position already mentioned above. For this purpose, within the scope of the simulation the carrier 17 might be traversed, by appropriate control of drive B of the carrier-conveyor 16, along a traversing path S represented in FIG. 2 into the target position or synchronous position shown in FIG. 6b (immediately after the alignment, described above, of the pouch 14).

Overall, collision-free traversing paths can be determined within the scope of the simulations for all the machine elements 12, 14, 17 (and/or further machine elements).

In a further, final step, the computed traversing paths can then be implemented in the real packaging machine 10 by methods of control engineering, for instance within the scope of a “master-slave” control principle with the aid of a control unit 25 which sends appropriate control instructions to the drives A, B and C.

For instance, in the course of initial operation of the packaging machine 10, in the course of putting it into operation after a stoppage of the machine, or after maintenance or within the scope thereof, if the machine 10 is frequently still in an undefined or unsynchronized state the machine 10, or the machine elements 12, 14, 17, can be moved, with the aid of the collision-free traversing paths computed in the described manner on the basis of the queried actual positions, into a defined, synchronized state.

If the method according to the invention is to be utilized for the purpose of monitoring or controlling the running or operational machine 10, the determination of the actual positions of the drives A, B, C, the determination of the aforementioned separations and also, overall, the simulation for the purpose of computing collision-free traversing paths are preferably undertaken continuously during ongoing operation or at least at certain, short time-intervals. In this process the traversing paths are recomputed accordingly in each instance and then communicated to the drives as control instructions.

### LIST OF REFERENCE SYMBOLS

10 packaging machine
11 cigarettes
12 pusher
13 cigarette magazine
14 pouches
15 pouch-conveyor
16 carrier-conveyor
17 carrier
18 region of overlap
19 wrapping station
20 inner blank
21 carrier part
22 region of overlap
23 computing device
24 simulation model
25 control unit

1. A method for controlling a packaging machine for producing wrappers, in particular for producing wrappers for smokable products of the tobacco industry, with several drives (A, B, C) capable of being activated independently of one another which move machine elements (12, 14, 17) of the packaging machine on trajectories on which the machine elements (12, 14, 17) might collide with one another or with another component of the packaging machine or with products being handled in the packaging machine, comprising the steps of:
a) creating a digital simulation model of the packaging machine, in particular by means of a simulation program, reproducing (at least) the drives (A, B, C) and the machine elements (12, 14, 17);
b) simulating, with the aid of the simulation model, differing relative positions of the drives (A, B, C) and the states of the packaging machine, in particular of the machine elements (12, 14, 17), arising at these relative positions;
c) ascertaining, within the scope of these simulations, collision-free traversing paths for the machine elements (12, 14, 17), in particular by means of a simulation program or the simulation program; and
d) moving the machine elements (12, 14, 17) of the packaging machine respectively along the ascertained collision-free traversing paths by appropriate control of the drives (A, B, C).

2. The method as claimed in claim 1, wherein the actual positions of the drives (A, B, C) of the packaging machine are queried, and in that on the basis of these actual positions the simulations are carried out and the collision-free traversing paths are determined, in particular by adapting the positions of the drives (A, B, C) of the simulation model to the queried actual positions of the respective assigned (real) drives (A, B, C) of the packaging machine within the scope of the simulations, so that the positions of the drives (A, B, C) in the simulation model correspond to the actual positions of the assigned drives (A, B, C) in the packaging machine.

3. The method as claimed in claim 1, wherein the actual positions of the drives (A, B, C) of the packaging machine are queried, and in that on the basis of these actual positions collision-free traversing paths previously ascertained within the scope of the simulations are selected from a database in which collision-free traversing paths assigned to various actual positions of the drives (A, B, C) of the packaging machine have been stored.

4. The method as claimed in claim 1, wherein the trajectories of at least two machine elements (12, 14, 17) intersect in a region of overlap, and in that separations between the two machine elements (12, 14, 17) and/or between one of these machine elements (12, 14, 17) and a product moved by the other machine element and/or between products moved by the two machine elements (12, 14, 17)—in particular, separations between the contours of the machine elements (12, 14, 17) and/or between the contours of the machine element and of the product and/or between the contours of the products—that arise when the two machine elements (12, 14, 17) are located in the region of overlap are determined within the scope of the simulations for differing relative positions of the drives (A, B, C) of the two machine elements (12, 14, 17).

5. The method as claimed in claim 4, wherein these separations are optimized within the scope of the ascertainment of collision-free traversing paths for the two machine elements (12, 14, 17), in particular in such a manner that the separations in the region of overlap are at least greater than zero or preferably as large as possible.

6. The method as claimed in claim 1, wherein separations between the machine element moved by said drive and/or a product moved by this machine element, on the one hand, and a stationary component of the apparatus, on the other hand—in particular, separations between the contour of the machine element and/or of the product moved by it, on the one hand, and the contour of the stationary component, on the other hand—that arise when the machine element is moved in or along the region of the stationary component are determined within the scope of the simulations for differing relative positions of (at least) one drive.

7. The method as claimed in claim 6, wherein the separations are optimized within the scope of the ascertainment of collision-free traversing paths for the machine element, in particular in such a manner that the separations during the entire traversing path are at least greater than zero or preferably as large as possible.

8. The method as claimed in claim 1, wherein separations between a predetermined synchronous position or target position for the machine element moved by the drive and the position of this machine element arising at the respective relative position of the drive are determined within the scope of the simulations for differing relative positions of (at least) one drive.

9. The method as claimed in claim 8, wherein the separations enter into the ascertainment of a collision-free traversing path for this machine element or further machine elements (12, 14, 17).

10. The method as claimed in claim 1, wherein the simulation model encompasses all the drives (A, B, C) and the machine elements (12, 14, 17) moved by said drives and also at least all the other components of the packaging machine with which the machine elements (12, 14, 17) and/or the products moved by said machine elements might collide on their trajectories.

11. The method as claimed in claim 1, wherein the simulations and the determination of the collision-free traversing paths are carried out during the operation of the packaging machine, in particular cyclically or continuously, or before or during a process of putting the packaging machine into operation or before or during maintenance thereof, in particular in each instance after a query of the actual positions of the drives (A, B, C) of the machine elements (12, 14, 17).

12. The method as claimed in claim 1, wherein the simulations, inclusive of the determination of the collision-free traversing paths, are performed by one or more computing devices, in particular assigned to the packaging machine, preferentially by the central main control unit of the packaging machine or by one or more decentralized control units, in particular controlling the respective drive.

13. The method as claimed in claim 1, wherein the machine elements (12, 14, 17) are moved respectively along the ascertained collision-free traversing paths by the appropriate control of the drives (A, B, C) during the operation of the packaging machine or during a process of putting it into operation or during maintenance thereof.

14. The method as claimed in claim 1, wherein within the scope of the ascertainment of the collision-free traversing paths a first collision-free traversing path is ascertained for a first machine element, and a second collision-free traversing path is ascertained for a second machine element, and in that the control of the drives (A, B, C) is undertaken in such a manner that the second machine element is moved along the second collision-free traversing path only when the first machine element has already been moved along the first collision-free traversing path.

15. An apparatus for producing wrappers, in particular for producing wrappers for smokable products of the tobacco industry, comprising several drives (A, B, C) capable of being activated independently of one another which respectively move at least one machine element of the apparatus on a trajectory on which the machine elements (12, 14, 17) might collide with one another or with another component of the apparatus or with products being handled in the apparatus, in which connection a computing device has been assigned to the apparatus, in particular exhibits said device, which has been designed and set up in such a manner that a digital simulation model of the packaging machine, reproducing at least the drives (A, B, C) and the machine elements (12, 14, 17), is capable of being created with it, in particular by means of a simulation program installed on the computing device, with the aid of which differing relative positions of the drives (A, B, C) and the states of the packaging machine arising in these relative positions, in particular of the machine elements (12, 14, 17), are capable of being simulated, in which connection collision-free traversing paths for the machine elements (12, 14, 17) are capable of being ascertained within the scope of these simulations, and that a drive controller which controls the drive in such a manner that the movable machine element is moved, or capable of being moved, along the ascertained collision-free traversing paths has been assigned to each drive.

16. The apparatus as claimed in claim 15, structured for carrying out a method for controlling a packaging machine for producing wrappers, in particular for producing wrappers for smokable products of the tobacco industry, with several drives (A, B, C) capable of being activated independently of one another which move machine elements (12, 14, 17) of the packaging machine on trajectories on which the machine elements (12, 14, 17) might collide with one another or with another component of the packaging machine or with products being handled in the packaging machine, the method comprising steps:
a) creating a digital simulation model of the packaging machine, in particular by means of a simulation program, reproducing (at least) the drives (A, B, C) and the machine elements (12, 14, 17);
b) simulating, with the aid of the simulation model, differing relative positions of the drives (A, B, C) and the states of the packaging machine, in particular of the machine elements (12, 14, 17), arising at these relative positions;
c) ascertaining, within the scope of these simulations, collision-free traversing paths for the machine elements (12, 14, 17), in particular by means of a simulation program or the simulation program; and
d) moving the machine elements (12, 14, 17) of the packaging machine respectively along the ascertained collision-free traversing paths by appropriate control of the drives (A, B, C).
